(19) United States
(12) Patent Application Publication
(10) Pub. No.: US 2011/0017239 A1
(43) Pub. Date: Jan. 27, 2011

(54) Detergent Composition

(75) Inventors: Dietmar VanLoyen, Ludwigshafen (DE); Judith Preuschen, Ludwigshafen (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckier N.V., Hoofddorp (NL)

(21) Appl. No.: 12/673,843

(22) PCT Filed: Aug. 20, 2008
(86) PCT No.: PCT/GB08/02819

§ 371 Date: May 18, 2010

(30) Foreign Application Priority Data
Aug. 20, 2007 (GB) 0716228.2

(51) Int. Cl. A47L 15/42; C11D 17/00

(52) U.S. Cl. 134/25.2; 510/224

(57) ABSTRACT

A shaped body of detergent composition comprising a chemically and/or physically cross-linked dissolution retarding agent, and at least one of a surfactant and/or builder. The dissolution retarding agent is preferably a copolymer of N-vinylpyrrolidone, 2-acrylamido-2-methylpropanesulfonic acid and a cross-linking agent, or a salt thereof. The shaped bodies dissolve predominantly in the main wash of an automatic washing process and do not dissolve significantly in the pre-wash and are of particular application in automatic dishwashing.

### TECHNICAL FIELD

The invention relates to a detergent shaped body for use in automatic washing machine, particularly an automatic dishwashing machine, the shaped body having dissolution properties such that it does not substantially dissolve prior to the main wash cycle.

### BACKGROUND AND PRIOR ART

Existing commercial washing compositions, such as laundry and dishwashing compositions may take the form of tablets which are usually formed by compression and consolidation of particulated compositions. Such tablets are often individually wrapped in order to keep them in good condition prior to use. However it is an inconvenience for consumers to unwrap a tablet each time they want to carry out a laundry or dishwashing cycle and also to put a tablet into the automatic washing machine each time they want to use it.

Automatic dispensing machines which are filled with a plurality of unit dose detergent portions and which deliver one or more of these portions per wash over a series of washes are already known in the art, see for example US2005/0139241 and US2002/0117511.

Such machines have the benefit for the consumer that they remove the need for placing a tablet inside an automatic laundry or dishwashing machine each time that the machine is to be used, rather the machine is filled with the unit dose detergent portions only once in a given number of washes. This allows the consumer to save time introducing detergent into the washing machine at each wash and significantly reduces the likelihood of the machines being run without detergent in the wash cycle.

Typically as these automatic dispensing devices dispense individual portions of detergent compositions into the wash cycles, these portions are in the form of a shaped body such as a compressed detergent tablet, bar or stick. However, a problem which faces the formulator of such compositions is that the compositions are contacted with water in the device not only during the main wash cycle but also during the pre-wash cycle of the cycle into which they are dosed. Typically only one unit dose detergent portion is exposed to the water inside the automatic washing machine during any given cycle.

The formulator must therefore carefully control the dissolution properties of the detergent compositions used to produce the unit dose detergent portions to ensure that they do not dissolve too much in the pre-wash cycle and accordingly leave insufficient detergent composition remaining of that unit dose detergent portion to provide effective cleaning in the main wash cycle.

Cross linked polymers have been used to control the release of active substances, see US 2004/106534. Polymers have also been used to coat detergent compositions to delay the release thereof, see e.g. US 2004/0106534 and US 2002/0010123.

WO 2007/052004 discloses that the addition of dissolution retarding such as polyvinyl-pyrrolidone (PVP) can have a significant impact on the dissolution speed of detergent composition elements in an automatic washing cycle e.g. in a dishwasher. The dissolution speed of the composition can be reduced with increasing concentrations of PVP; thus a composition comprising 5 wt % of PVP will typically dissolve more slowly than a composition comprising 0.5 wt %. This allows for more of the composition to dissolve in the main wash cycle thus improving the cleaning performance. EP-A-481 547 discloses that polymeric layers may be used as barrier layers to provide sequential release in machine dishwashing detergents having concentric layers.

Copolymers containing monomers of 2-acrylamido-2-methylpropanesulphonic acid have also been proposed for us in reabsorbing detached dyestuff in U.S. Pat. No. 5,607,618.

Without wishing to be bound by theory it is believed that PVP acts as an adhesive within a formulation. This action produces a decrease in the rate of dissolution.

However, there is still the need in the art to provide detergent compositions which dissolve predominantly in the main wash cycle of an automatic washing machine even after being exposed to a pre-wash cycle. In particular there is the need to provide such detergent compositions which have better dissolution characteristics in this regard than those compositions formulated with PVP in order to optimise performance and/or reduce the amount of formulation space taken up by the dissolution retarding agent thus leaving more space in the compositions for other active ingredients.

In particular, there is a need to provide such detergent compositions which are suited to being present over one or more washing cycles in an automatic dispensing device before being dispensed into the washing machine. The composition will usually be retained in a series of separate chambers in the device or in a cartridge placed inside the device and some of the unit dose detergent portions formed from the composition will be present in the automatic washing machine for several cycles.

The present invention seeks to address one or more of the aforementioned problems. In particular, it is an aim of the present invention to provide detergent compositions which dissolve more slowly than the equivalent composition comprising PVP as a dissolution retarding agent and/or which require less dissolution retarding agent to achieve the same dissolution properties. There is also a need to provide detergent compositions which are suited to being present over one or more washing cycles in an automatic dispensing device before being dispensed into the washing machine and which are not significantly adversely affected by the conditions within the automatic washing machine during that time.

### STATEMENT OF INVENTION

Surprisingly we have found that when certain polymers are used as ingredients in shaped detergent compositions, the dissolution properties of the compositions can be controlled such that they exhibit good delayed dissolution characteristics compared to equivalent compositions not comprising the polymers.

In accordance with a first aspect of the present invention there is provided a shaped body of detergent composition comprising a chemically and/or physically cross-linked dissolution retarding agent, and at least one of a surfactant and/or builder.

It is especially preferred that the dissolution retarding agent comprises a copolymer as defined in any of claims 2 to 9. It is also preferred that the composition comprises an amount of from 0.01-10% wt of the dissolution retarding agent.

It is preferred that when a builder is present it comprises at least one of polycarboxylate builders, succinate builders, amino acid based builders and/or phosphorous based builders. Preferably the composition comprises an amount of from 5 to 80% wt builder.

If the shaped body comprises surfactant it is preferred that it comprises non-ionic surfactant, preferably in an amount of from 0.2 to 30% wt.

It is also preferred that a shaped body according to the invention prepared by tabletting 9.5 g of the detergent composition (used to form the shaped body) using a Kilian® SP 300 excentric press applying a pressing force of 70 KN to produce a tablet hardness of between 200 to 400 N has a dissolution time of from 300 to 650 seconds in 40° C. water, tested using a Disintegration-Tester Erweka® ZT 54 machine operating at 68 strokes per minute.

Preferably the shaped body is produced by compaction of the detergent composition. Shaped bodies in the form of a tablet, stick or ball are preferred.

The shaped body may be any type of detergent composition such as hard surface cleaning composition, laundry composition or dishwashing composition, with dishwashing compositions being especially preferred.

The compositions according to the first aspect do not dissolve to a significant extent in the cold water prewash but rather dissolve predominantly in the main wash cycle of an automatic washing cycle, which is typically carried out in warmer water. This effect is achieved using relatively low levels of the dissolution retarding agent polymer thus providing greater formulation flexibility. The dissolution retarding agents of the present invention are capable of being either chemically or physically cross-linked (and preferably both) in the detergent compositions. It has been found that such dissolution retarding agents provide effective results at low concentrations in the compositions.

It has also been found that the present invention provides a detergent composition exhibiting good physical stability when it is stored in a dispensing device in an automatic washing machine, in particular in a dishwasher and at least partially exposed to the conditions therein (although not deliberately directly contacted with water), over two or more washes. In particular, good stability is exhibited across the total number of unit dose detergent portions made from the composition of the invention present in the dispensing device, so that physical characteristics such as dissolution or performance are not significantly different between the first and last unit dose detergent portion in the device after storage in the dishwasher.

In accordance with a second aspect of the invention there is provided a detergent delivery cartridge, the cartridge comprising a shaped body according to the first aspect of the invention.

It is preferred that the delivery cartridge is a refill device having a plurality of chambers which retain said unit dose elements, the unit dose elements being separate from each other, the delivery cartridge being adapted for engagement in a housing, the housing being built into a dishwasher or independent of the dishwasher.

In accordance with a third aspect of the invention there is provided a detergent dispensing device comprising a shaped body according to the first aspect of the invention, or, a detergent delivery cartridge according to the second aspect of the invention.

In accordance with a fourth aspect of the invention there is provided a method of washing wares in an automatic washing machine, using a shaped body according to the first aspect, a detergent cartridge according the second aspect or a detergent dispenser according to the third aspect.

It is especially preferred that the method comprises kitchen ware being washed in an automatic dishwashing machine.

In accordance with a fifth aspect of the invention there is provided the use of a dissolution retarding agent as according to the first aspect of the invention in a shaped body of detergent composition to retard the dissolution the shaped body.

Throughout this specification “wt %” or “% wt” denotes the weight of the named component as a percentage of the total weight of the composition, unless otherwise stated explicitly.

The term “dissolution retarding agent” as used herein means that the agent retards (slows down) the rate of dissolution of the material into which it is incorporated compared to the rate of dissolution of a composition which is otherwise identical except for the omission of the dissolution retarding agent.

The term “physically crossed linked” as used herein means cross linking which is effected through ionic bonding. This physical cross linking is reversible for example by the effect of temperature, pH or ionic strength of a solution.

The term “detergent delivery cartridge” as used herein means an external cover surrounding at least a part, and preferably all, of the detergent shaped body and from which the shaped body is delivered in use e.g. into the wash liquor in an automatic dishwasher. Preferably the detergent delivery cartridge is substantially water insoluble.

### DETAILED DESCRIPTION

The invention will now be described in further detail.

### Form of the Compositions

The compositions of the present invention are in the form of a shaped body which are used as unit dose detergent portions (which may be dosed singularly or in combination in a washing operation).

The size and weight of the shaped body can be altered as desired. Any suitable shape may be used for the body such as a (substantially rectangular) tablet, stick or ball and these shapes are preferred according to the present invention. More complex shapes may also be used such as cubes, pentagons, hexagons, pyramids or prisms etc.

The shaped bodies are suitable for use in any automatic washing machine where they can be placed directly in the washing cavity or the dosing chamber of that machine. However, it is especially preferred that the shaped bodies are dishwashing compositions and are used in automatic dishwashing machines.

### Dissolution of the Compositions

Whilst the shaped bodies of the invention should dissolve predominantly in the main wash of an automatic washing machine, the dissolution characteristics should not be changed by the presence of the dissolution retarding agent to such an extent that the bodies become insoluble, do not dissolve in water at the temperatures used in dishwashing machines or dissolve so slowly that they do not provide effective cleaning. Accordingly the composition according to the invention preferably exhibits a dissolution time according to the following test of from 300 to 650 seconds, preferably 350-600 seconds, such as 370 to 550 seconds.

### Dissolution Test;

Shaped bodies of detergent composition to be tested are prepared by tabletting 9.5 g of the composition using a Kilian® SP 300 excentric press applying a pressing force of 70 KN resulting in a tablet hardness of between 200 to 400N. The tablets have dimensions of about 43×16×10 mm. The dissolution time of the shaped body is tested using a Disintegration-Tester (Erweka® ZT 54; modified to include a more powerful motor than that fitted as standard) to raise and lower a metal mesh basket in a beaker of water 68 times (strokes) per minute. Two tablets are placed in the metal mesh test basket (having a circular mesh size of 5 mm diameter which fits inside a 1 litre glass beaker. The tablets and basket are immersed into 900 ml of tap water in the 1 litre glass beaker and held at a constant temperature of 40° C. in a water bath. The time taken for the tablets to dissolve so such that there are no parts of the tablet remaining in the basket is recorded in seconds.

It is preferred that the shaped bodies of the invention remain substantially undissolved in the prewash stage of a dishwashing or laundry machine and substantially dissolve in the main wash. The dissolution speed of the shaped bodies is of course dependent on the temperature, leading ideally to slow and/or little dissolution in cold water and fast and/or substantial dissolution in hot water (main wash cycle).

### Detergent Delivery Cartridge and Dispensing Device

The shaped bodies of the invention are preferably contained in any suitable detergent delivery cartridge, preferably one having a plurality of chambers each containing a separate shaped body. The delivery cartridge is preferably adapted for engagement in a dispensing device which itself is built-into the washing machine (especially a dishwasher) or is independent thereof. However, the precise design of the delivery cartridge or dispensing device is not critical to the present invention. It is however possible to dose the shaped bodies of the invention without the use of either a delivery cartridge or dispensing device.

One advantage of the present invention is that the shaped bodies described herein can survive repeated exposure to warm and humid conditions such as those found in a dishwashing machine. This offers the possibility of multi-dose delivery cartridges being used in dispensing devices in automatic washing operations, especially in dishwashers.

The shaped bodies of detergent composition according to the invention may, in addition or instead of being placed in a delivery cartridge, be coated with an agent which screens them from the atmosphere e.g. such as a suitable plastic cover. However this may not be needed.

### Dissolution Retarding Agent

The compositions of the invention comprise a dissolution retarding agent so that the speed of dissolution of the composition is slowed compared to the same composition which does not contain the dissolution retarding agent. This allows for the composition to dissolve predominantly in the main wash of an automatic washing process rather than in the pre-wash.

We have found that certain types of agents are very effective dissolution retarding agents and as such are of particular application in the compositions of the invention. These agents are copolymers (or the alkali metal, alkaline earth metal, ammonium or transition metal salt thereof) formed from the copolymerisation of acrylamidoalkylsulphonic acids with either;

a) at least one cyclic N-vinylcarboxamide, vinyl acetate, ethyleneimine, vinyl imidazole, acrylic acid or maleic acid, or
b) (i) at least one cyclic N-vinylcarboxamide, vinyl acetate, ethyleneimine, vinyl imidazole, acrylic acid or maleic acid and (ii) at least one linear N-vinylcarboxamide, or the alkali metal, alkaline earth metal, ammonium or transition metal salt thereof.

These copolymers may be formed optionally with one or more further monomers, including, monomers which act as cross-linking agents.

Such copolymers where a) is at least one cyclic N-vinylcarboxamide are commercially available and are known for use in cosmetic and pharmaceutical applications. Their preparation and use in cosmetic and pharmaceutical applications is fully described in EP-A-1116733. The use of these copolymers as thickening agents for liquid washing, bleaching, disinfecting and bleaching compositions is disclosed in EP-A-1477553.

The dissolution retarding agents preferably used according to the present invention are cross-linked copolymers comprising;

a1) 1 to 50% by weight of either the repeating structural unit of the formula (1);

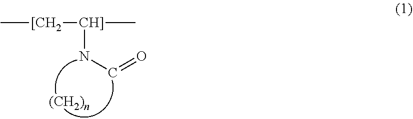

where n is an integer from 2 to 9; or vinyl acetate, ethyleneimine, vinyl imidazole, acrylic acid or maleic acid, or
a2) 1 to 50 wt % of a mixture of (i) the repeating structural unit of formula (1) above or vinyl acetate, ethyleneimine, vinyl imidazole, acrylic acid or maleic acid and (ii) of the repeating structural unit of formula (2);

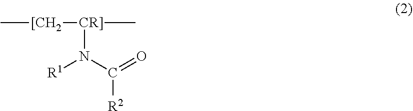

where R, R¹ and R² may be identical or different and are hydrogen or a linear or branched alkyl or alkenyl group having in each case 1 to 30, preferably 1 to 20, in particular 1 to 12, carbon atoms and
b) 49.99 to 98.99% by weight of the repeating structural unit of the formula (3);

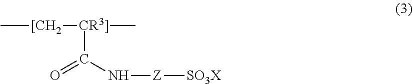

in which R³ is hydrogen, methyl or ethyl, Z is C₁-C₈-alkylene, n is an integer from 2 to 9, and X is an alkali metal ion, an alkaline earth metal ion, ammonium, or a transition metal ion, and
c) optionally 0.01 to 8% by weight of cross-linking structures resulting from monomers having at least two olefinic double bonds.

The above copolymers preferably consist essentially of the aforementioned monomers in (a) to (c), and most preferably (a) is the repeating structural unit of formula (1). However, it is also possible that these copolymers comprise as additional monomers (d) to produce terpolymers (when (a) is at least one cyclic N-vinylcarboxamide) one or more of the following monomers; vinyl acetate, ethyleneimine, vinyl imidazole, acrylic acid or maleic acid. If terpolymers are produced, it is preferred that monomer (d) replaces up to 50% wt of the total amount of al and/or a2 used in the corresponding polymer without (d) present, preferably (d) replaces 1 to 40% wt, more preferably 5 to 30% wt.

It is preferred that the copolymers are water-soluble or water-swellable.

It is preferred that the copolymer comprises 0.01 to 5% by weight, of cross-linking structures resulting from monomers having at least two olefinic double bonds.

Preferred dissolution retarding agents used in the compositions of the present invention are copolymers of the above type comprising;
from 2 to 30 wt % of structural units of the formula (1), or (1) and (2), preferably derived from N-vinylpyrrolidone,
69.5 to 97.5 wt % of structural units of the formula (3), preferably derived from a salt of 2-acrylamido-2-methylpropanesulphonic acid,
0.2 to 3 wt % of cross-linking structures resulting from monomers having at least two olefinic double bonds,
   and most especially the alkali metal, alkaline earth metal, ammonium or transition metal salts thereof.

It is most preferred that the dissolution retarding agents used in the compositions of the present invention are copolymers of the above type comprising;
from 3 to 15 wt % of structural units of the formula (1), or (1) and (2), preferably derived from N-vinylpyrrolidone,
84.5 to 96.5 wt % of structural units of the formula (3), preferably derived from a salt of 2-acrylamido-2-methylpropanesulphonic acid,
0.5 to 2 wt % of cross-linking structures resulting from monomers having at least two olefinic double bonds,
   and most especially the alkali metal, alkaline earth metal, ammonium or transition metal salts thereof, in particular the sodium, potassium, calcium, manganese, zinc, bismuth or cobalt salts thereof.

It is preferred according to the present invention that the sodium, potassium or calcium salts of the aforementioned co-polymers are used, especially the sodium salts. Transition metal salts, especially manganese, zinc, bismuth and cobalt may also be used. The ammonium salt may be used but this is less preferred for alkaline compositions as the ammonium anion is unstable under alkaline conditions resulting in off-odours.

The ratio of the monomers forming the basis of structural units 1 and 2 above can be varied within any desired limits.

Cross-linking structures resulting from monomers having at least two olefinic double bonds are preferably derived from allyl acrylate or allyl methacrylate, dipropylene glycol diallyl ether, polyglycol diallyl ether, triethylene glycol divinyl ether, hydroquinone diallyl ether, tetraallyloxyethane or other allyl or vinyl ethers of multifunctional alcohols, tetraethylene glycol diacrylate, triallylamine, trimethylolpropane diallyl ether, methylene bisacrylamide or divinylbenzene, especially allyl (meth)acrylate. The cross-linking structures are particularly preferably derived from monomers of the formula (4), in which R is hydrogen, methyl or ethyl;

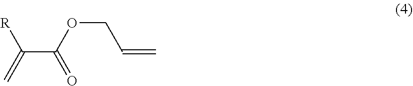

It is especially preferred according to the present invention that in the dissolution retarding agent structure 1 is N-vinylpyrrolidone, structure 3 is 2-acrylamido-2-methylpropanesulphonic acid and structure 4 is trimethylolpropanetriacrylate. It is further preferred that the alkali or alkaline earth metal salt of this copolymer is used, in particular the sodium, potassium, ammonium, magnesium or calcium salts or that transition metal salts are used such as manganese, zinc, bismuth or cobalt.

The dissolution retarding agent is preferably used in the compositions of the invention an amount of from 0.01 to 10 wt %, more preferably 0.05 to 5 wt %, most preferably 0.1 to 3 wt %, such as 0.15 to 2 wt %.

### Builders

The detergent compositions may also comprise conventional amounts of detergent builders which may be either phosphorous based or non-phosphorous based, or a combination of both types. Suitable builders are well known in the art.

If phosphorous containing builders are to be used then it is preferred that mono-phosphates, di-phosphates, tri-polyphosphates, polyphosphonates or oligomeric-polyphosphates are used. The alkali metal salts of these agents are preferred, in particular the sodium salts. An especially preferred phosphorous containing builder is sodium tripolyphosphate (STPP).

The non-phosphorous containing builder may be organic molecules with carboxylic group(s), amino acid based compounds, a succinate based compound or a mixture thereof. The term ‘succinate based compound’ and ‘succinic acid based compound’ are used interchangeably herein and these compounds are further described below.

Builder compounds which are organic molecules selected from water-soluble monomeric polycarboxylic acids and/or their acid forms may also be used according to the invention. Suitable polycarboxylic acids include acyclic, alicyclic, heterocyclic and aromatic carboxylic acids. Suitable examples of such compounds include citric acid, fumaric acid, tartaric acid, maleic acid, (ethylenedioxy)diacetic acid, tartronic acid, lactic acid, glycolic acid, malonic acid, diglycolic acid and fumaric acid and salts and derivatives thereof, especially the water soluble salts thereof. Preferred salts of the abovementioned compounds are the ammonium and/or alkali or alkaline earth metal salts, e.g. the ammonium, lithium, sodium, potassium or calcium salts, and particularly preferred salts are the sodium salts. These acids may be used in their monomeric or oligomeric form. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid and salts and derivatives thereof). Other suitable builders are described in U.S. Pat. No. 6,426,229 which is incorporated by reference herein.

In particular suitable builders include; for example, aspartic acid-N-monoacetic acid (ASMA), aspartic acid-N,N-diacetic acid (ASDA), aspartic acid-N— monopropionic acid (ASMP), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulphanilic acid-N,N-diacetic acid (SLDA), taurine-N,N-diacetic acid (TUDA) and sulphomethyl-N,N-diacetic acid (SMDA) and alkali metal salts or ammonium salts thereof.

A preferred MGDA compound is a salt of methyl glycine diacetic acid. Suitable salts include the triammonium salt, the tripotassium salt and, preferably, the trisodium salt. A preferred GLDA compound is a salt of glutamic diacetic acid. Suitable salts include the tetraammonium salt, the tetrapotassium salt and, preferably, the tetrasodium salt.

Preferred succinate compounds are described in U.S. Pat. No. 5,977,053 and have the formula;

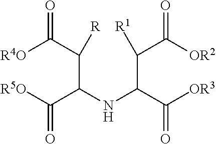

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. Iminodisuccinic acid (IDS) and (hydroxy)iminodisuccinic acid (HIDS) and alkali metal salts or ammonium salts thereof are especially preferred succinate based builder salts.

MGDA, GLDA, IDS and HIDS are especially preferred builders according to the present invention. Any suitable form of the amino acid and succinate based compounds in the preceding paragraph may be used.

According to one aspect of the invention it is preferred to use a combination of different builders, especially when it is desired to control further the dissolution characteristics of the composition and/or the performance. A preferred combination according to the present invention is of amino acid based or succinate based builders with phosphorous containing builder(s) or with a non-phosphorous containing builder(s), for example a combination of amino acid based builders with non phosphorous builders such as polycarboxylates or phosphate based builders. Suitable combinations include for example an amino acid based builder, such as MGDA or GLDA with a citrate builder or a polyphosphate builder such as a tripolyphosphate. The ration of the different builder types could vary according to the builder types and overall formulation of the composition, however, for some applications it is preferred that the amount of non-phosphate builder to phosphate builder is in the weight ratio range of from 20:1 to 1:10, more preferably 10:1 to 1:5, such as 5:1 to 1:2, for example 2:1 to 1:1.

If an amino acid based builders e.g. MGDA and/or GLDA are/is present in the composition according to the invention in combination with any phosphorous containing builder it is preferably used in an amount of at least 20 wt %, more preferably at least 25 wt %, most preferably at least 30 wt %. Preferably in this type of composition the MGDA and/or GLDA is present in an amount of up to 50 wt %, more preferably up to 45 wt % and most preferably up to 40 wt %.

If an amino acid based builder e.g. MGDA and/or GLDA are/is present in the composition according to the invention in the absence of any phosphorous containing builder it is preferably used in an amount of at least 30 wt %, more preferably at least 40 wt %, most preferably at least 45 wt %, especially at least 50 wt %. Preferably in this type of composition the MGDA and/or GLDA is present in an amount of up to 70 wt %, more preferably up to 65 wt % and most preferably up to 60 wt %.

It is preferred according to the present invention that the builder comprises at least one of polycarboxylate builders, amino acid based builders, succinate based builders and/or phosphorous based builders.

An inorganic non-phosphorous containing builder may be present in the compositions. Suitable inorganic non-phosphorous containing builders may include borates and aluminosilicates. For dishwashing compositions according to the invention it is preferred that aluminosilicates are used in amounts of 10% wt or less and preferably are absent. However, for laundry formulations aluminosilicates are a preferred ingredient.

Preferably the total amount of builder present in the compositions of the invention is an amount of at least 5 wt %, preferably at least 10 wt %, more preferably at least 20 wt %, and most preferably at least 25 wt %. The total amount of builder is preferably an amount of up to 80 wt %, preferably up to 70 wt %, more preferably up to 60 wt %, and most preferably up to 50 wt %. The amount of builder is preferably in the amount of from 5 to 80% wt of builder. The actual amount used will depend upon the nature of the builder used.

The compositions of the invention may further comprise a secondary builder (or cobuilder). Secondary builders which are organic are preferred.

Preferred secondary builders include homopolymers and copolymers of polycarboxylic acids and their partially or completely neutralized salts. Preferred salts of the abovementioned compounds are the ammonium and/or alkali metal salts, i.e. the lithium, sodium, and potassium salts, and particularly preferred salts are the sodium salts.

A suitable polycarboxylic acid co-builder is the homopolymer of acrylic acid and the salts and derivatives thereof. Other suitable organic builders are co-polymers of acrylic acid with maleic acid and salts and derivatives thereof. Other suitable builders are disclosed in WO 95/01416, to the contents of which express reference is hereby made. Typically the number average molecular weight of the polymer will be in the range of from 2,000 to 15,000, more preferably 2,500 to 10,000, such as 3,000 to 7,000, e.g. 4,000 to 5,000.

### Surfactant

The compositions of the invention may contain surface active agents such as an anionic, non-ionic, cationic, amphoteric, gemini (dimeric) or zwitterionic surface active agents or mixtures thereof. Many such surfactants are described in Kirk Othmer's Encyclopedia of Chemical Technology, 3rd Ed., Vol. 22, pp. 360-379, “Surfactants and Detersive Systems”, incorporated by reference herein. When a surfactant is present a non-ionic surfactant is preferred.

A surfactant, or surfactants, may be present in the composition in an amount of at least 0.2 wt %, preferably at least 0.5 wt %. more preferably at least 1 wt %, even more preferably at least 2 wt %, most preferably at least 2.5 or 3 wt % (total complement). A surfactant, or surfactants, may be present in the composition in an amount of up to 20 or 30 wt %, preferably up to 10 wt %, more preferably up to 5 wt % (total complement). It is preferred that the shaped bodies comprise surfactant, especially non-ionic surfactant in an amount of from 0.2 to 30% wt.

One possible class of non-ionic surfactants are alkoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of alkylene oxide per mole of alcohol or alkylphenol. Any combination of alkylene oxides may be used, for example ethylene oxide, butylene oxide and propylene oxide and mixtures thereof. Ethylene oxide is frequently the preferred alkylene oxide.

Particularly preferred non-ionic surfactants are the non-ionics from a linear chain fatty alcohol with 16-20 carbon atoms and at least 12 moles, more preferably at least 16 and still more preferably at least 20 moles of alkylene oxide per mole of alcohol. The comments in the preceding paragraph regarding the alkylene oxide apply equally here.

According to one preferred embodiment of the invention, the non-ionic surfactants additionally comprise propylene oxide units in the molecule. Preferably these PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of non-ionic surfactant can be described by the formula:

R¹O[CH₂CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred non-ionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propel, isopropyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where groups with 8 to 18 carbon atoms are particularly preferred. For the R³ group H, methyl or ethyl is particularly preferred. Particularly preferred values for x are those of from 1 to 20, preferably from 6 to 15.

As described above, in case x>2, each R³ in the formula can be different. For instance, when x=3, the group R³ could be chosen to build ethylene oxide (R³=H) or propylene oxide (R³=methyl) units which can be used in any order for instance; (PO)(EO)(EO), (EO)(PO)(EO), (EO)(EO)(PO), (EO)(EO)(EO), (PO)(EO)(PO), (PO) (PO) (EO) and (PO)(PO)(PO).

The above value of 3 for x is only an example and higher values can be chosen whereby a higher number of variations of (EO) or (PO) units would arise accordingly.

Particularly preferred end-capped polyoxyalkylated alcohols of the above formula are those where k=1 and j=1 providing molecules of simplified formula:

R¹O[CH₂CH(R³)O]_{X}CH₂CH(OH)CH₂OR²

Mixtures of two or more non-ionic surfactants may be used according to the present invention, for instance, mixtures of alkoxylated alcohols and hydroxy group containing alkoxylated alcohols.

### Enzymes

The compositions according to the invention may also comprise enzymes, such as proteases, lipases, amylases, cellulases and peroxidases. Such enzymes are commercially available and sold, for example, under the trade marks Esperasek®, Alcalase® and Savinasek® by Novozymes® A/S and Properase® by Genencor®. Desirably the enzyme(s) is/are present in the composition in an amount of from 0.01 to 3 wt %, especially 0.1 to 2 wt % (total enzyme complement present).

### Sulphonated Polymers;

Sulphonated polymers are suitable for use in the compositions of the present invention and are a preferred ingredient thereof. These compounds are included to disperse calcium phosphate compounds and prevent their deposition onto the articles to be cleaned. Preferred examples of sulphonated polymers which may be used according to the invention include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulphonated monomers for incorporation in Sulphonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulphonated polymer is present, it is preferably present in the composition in an amount of at least 0.1 wt %, preferably at least 0.5 wt %, more preferably at least 1 wt %, and most preferably at least 3 wt %, especially at least 5 wt %. When a sulphonated polymer is present, it is preferably present in the composition in an amount of up to 40 wt %, preferably up to 25 wt %, more preferably up to 15 wt %, and most preferably up to 10 wt %.

### Binders;

Generally the composition according to the invention comprises a binder to help maintain the dimensional form of the composition, to increase hardness and to reduce friability.

Preferred examples of material that have a binder action include; polyethylene glycols, fatty acids and derivatives thereof, such as alkali metal and ammonium salts of fatty acid carboxylates (e.g. ammonium stearate, sodium oleate, potassium laureate), glycerol, polyethylene glycol (PEG)/glycerol functionalised with fatty acid carboxylates (e.g. PEG mono-oleate, PEG ricinoleate, glycerol mono-ricinoleate); sucrose glycerides and PVP.

Most preferably the binder comprises polyethylene glycol having a molecular weight of from 500 to 40000, more preferably of from 1000 to 30000 and most preferably of from 1200 to 25000. Grades of PEG are sold with reference to their nominal molecular weights; thus a PEG of molecular weight 500 to 30000 as referred to herein refers to its nominal molecular weight, based on the names under which the PEG compounds are sold.

A binder is preferably present at an amount of from 0.1 wt % to 10 wt %, more preferably from 2 wt % to 7 wt %, most preferably from 3 wt % to 6 wt %.

### Alkalinity Source;

The compositions according to the invention may also comprise a source of acidity or a source of alkalinity, to obtain the desired pH, on dissolution. A source of acidity may suitably be any suitable acidic compound for example a polycarboxylic acid or a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity. Preferred silicates are sodium silicates such as sodium disilicate, sodium metasilicate and crystalline phyllosilicates.

### Bleaches;

The compositions of the present invention may comprise bleach and bleach activators. However, as the compositions of the invention are generally intended to be exposed to a plurality of washing cycles in a reasonable high temperature and high humidity environment, it is preferred that the compositions comprise less than 10 wt % of a bleaching compound, more preferably less than 5 wt %, most preferably less than 2 wt % and in particular that they are free of a bleaching compound.

If a bleaching compound is used in the compositions of the invention, then any type of bleaching compound conventionally used in detergent compositions may be used. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

When a bleaching compound is present in the compositions in an amount of from 1 to 60 wt %, especially 5 to 55 wt %, most preferably 10 to 50% wt, such as 10 to 20% wt.

If a bleaching compound is used, it may be used with any suitable bleach activator compound which compound is used in any suitable amount.

### Other Optional Ingredients;

The detergent body may further include other common detergent components such as corrosion inhibitors (for example those for use in inhibiting the corrosion of silver or glass), fragrances, anti-bacterial agents, preservatives, pigments or dyes and preservatives.

The composition according to the invention may also comprise one or more foam control agents. Suitable foam control agents for this purpose are all those used in detergent compositions for use in automatic washing operations, such as, silicones and paraffin oil.

The foam control agents are preferably present in the composition in amounts of 5% by weight or less, preferably 3% by weight of less, most preferably 2% wt or less based on the total weight of the detergent.

### Manufacture of the Compositions;

The compositions of the present invention are very well adapted to manufacture by forming processes which involve elevating the temperature of the composition, then forming it to a shape when liquefied, or softened. Examples of such processes include injection moulding (e.g. in accordance with the process described in WO 2005/035709), pour-moulding or casting, and extrusion.

Extrusion processes are well known in the art and do not need to be further described here. In such processes the composition may be heated to a temperature in the range of from about 30 up to about 60° C., preferably 35 to 55° C., most preferably 40 to 50° C. It is found that the composition is not degraded to any substantive level if the temperatures are kept within this range. This is the case even when enzymes are present; enzymes being, of course, heat sensitive. Without wishing to be bound by theory the coherent form (e.g. matrix) of the composition may afford at least some degree of protection to the enzymes.

As an alternative, the compositions may be formed by a compression process as is well known in the art and does not need to be described further here. It is preferred according to one aspect of the invention that the e shaped body is produced by a compaction of the detergent composition. Tabletting is a conventional process for the manufacture of detergent compositions and the person skilled in the art is well informed as to suitable tabletting processes.

The invention will now be further described by way of example, with reference to the following non-limiting examples. Further modifications within the scope of the invention will be apparent to the person skilled in the art.

### EXAMPLES

### Example 1

### Citrate/MGDA Built Compositions Produced by Tabletting

Formulae 1 to 3 below were prepared using the components shown in Table 1 below. The formulae were added in the order given in Table 1 in a Ruberg-mixer 100 and mixed for 4 min at 47 rpm to produce a coherent formulation. Formula 1 is a comparative example comprising no dissolution retarding compound. Formula 2 is a composition according to the present invention. Formula 3 is a further comparative example comprising a PVP based dissolution retarding compound.

Formulae 1 to 3 were produced by tabletting the compositions using a Kilian® SP 300 excentric press applying a pressing force of 70 KN resulting in a tablet hardness of 200-400 N. The tablet had a weight of 9.5 g and dimensions of about 43×16×10 mm.

Alternatively, the compositions could have been extruded using suitable conditions to produce the detergent stick.

All amounts in Table 1 are given as the percentage of the stated raw material used to produce the formulae, based on the total weight of the formula. Formulae 1 and 3 are comparative examples.

The dissolution retarder agent is a copolymer wherein structure 1 is N-vinylpyrrolidone, structure 3 is 2-acrylamido-2-methylpropanesulfonic acid and structure 4 is trimethylolpropanetriacrylate. It is commercially available as Hostagel® AV ex Clariant®, Germany. This copolymer has an ammonium cation but the alkali or alkaline earth metal cations are easily substituted therefor.

TABLE 1

| | Formula 1 | | Formula 3 |
|---|---|---|---|
| | (comp) | Formula 2 | (comp) |
| raw materials | % wt | % wt | % wt |
| Trisodium citrate | 20.00 | 20.00 | 20.00 |
| Sodium disilicate | 3.00 | 3.00 | 3.00 |
| Sodium carbonate (soda) | 17.10 | 16.80 | 15.10 |
| Modified fatty alcohol | 1.00 | 1.00 | 1.00 |
| polyglycol ether *¹ | | | |
| Fatty alcohol ethoxylate *⁵ | 0.50 | 0.50 | 0.50 |
| Tetra sodium (1- | 0.50 | 0.50 | 0.50 |
| hydroxyethylidene) | | | |
| biphosphonate (HEDP) | | | |
| AMPS sulphonated polymer *² | 3.00 | 3.00 | 3.00 |
| Acrylic homopolymer *⁶ | 5.00 | 5.00 | 5.00 |
| Protease | 2.25 | 2.25 | 2.25 |
| Amylase | 0.50 | 0.50 | 0.50 |
| AMPS/N-Vinylpyrrolidone | — | 0.30 | — |
| copolymer crossed | | | |
| linked with TMPTA *³ | | | |
| Polyvinyl-pyrrolidone/ | — | — | 2.00 |
| vinyl acetate co-polymer | | | |
| (PVP/VA) *⁴ | | | |
| MGDA granules *⁷ | 40.50 | 40.50 | 40.50 |
| PEG 4000 | 3.00 | 3.00 | 3.00 |
| Fatty alcohol alkoxylate *⁸ | 3.00 | 3.00 | 3.00 |
| Glycerol 99% | 0.50 | 0.50 | 0.50 |
| Fragrance | 0.15 | 0.15 | 0.15 |
| Total | 100.00 | 100.00 | 100.00 |

*¹ Dehypon^{RTM} 3697 GRA M (ex Cognis^{RTM}, Germany),
*² Acusol^{RTM} 588G (ex Rohm & Haas^{RTM}),
*³ Hostagel^{RTM} AV (ex Clariant^{RTM}, Germany),
*⁴ Luvitech^{RTM} VA64 (ex BASF^{RTM}, Germany),
*⁵ Lutensol^{RTM} AT 25 (ex BASF^{RTM,} Germany),
*⁶ Acusol^{RTM} 445 NG (ex Rohm & Haas^{RTM}),
*⁷ Trilon^{RTM} M granules (ex BASF^{RTM,} Germany),
*⁸ Plurafac^{RTM} LF 226 (ex BASF^{RTM,} Germany).

The dissolution time of each of the three formulae was tested using a Disintegration-Tester (Erweka ZT 54) and the dissolution test method given hereinabove in the description. A longer dissolution time under the above test methods is preferred, although this should not be so long that the composition will not substantially dissolve in the wash.

The dissolution time at 40° C. for each formula was;

Formula 1 (no dissolution retarder agent)—285 seconds
Formula 2 (according to the invention)—377 seconds
Formula 3 (PVP dissolution retarder agent—312 seconds.

The above example clearly demonstrates that the compositions of the invention show superior dissolution retardation effects than the prior art PVP-based dissolution aids and this effect is even achieved at lower levels of ingredient. However, the compositions still dissolve in a suitable time for use in an automatic washing process such as in an automatic dishwashing process.

### Example 2

### Sodium Tripolyphosphate and MGDA Built Systems

Formulae 4 to 6 below were prepared using the components shown in Table 2 below. The formulae were added in the order given in Table 2 in a Ruberg-mixer 100 and mixed for 4 min at 47 rpm to produce a coherent formulation. All formulae are according to the present invention and show the effect of increasing the concentration of the amount of the dissolution retarder agent.

Formulae 4 to 6 were tabletted as for example 1 above. Alternatively, the compositions could have been extruded using suitable conditions to produce the detergent stick.

All amounts in Table 2 are given as the percentage of the stated raw material used to produce the formulae, based on the total weight of the formula.

TABLE 2

| | Formula 4 | Formula 5 | Formula 6 |
|---|---|---|---|
| raw materials | % wt | % wt | % wt |
| Sodium Tripolyphosphate | 23.85 | 23.85 | 23.85 |
| Sodium disilicate | 3.00 | 3.00 | 3.00 |
| Sodium carbonate (soda) | 19.05 | 18.85 | 18.65 |
| Modified fatty alcohol | 1.00 | 1.00 | 1.00 |
| polyglycol ether *¹ | | | |
| Fatty alcohol | 1.50 | 1.50 | 1.50 |
| ethoxylate *⁵ | | | |
| Tetra sodium (1- | 0.50 | 0.50 | 0.50 |
| hydroxyethylidene ) | | | |
| biphosphonate | | | |
| AMPS sulphonated polymer *² | 5.00 | 5.00 | 5.00 |
| Acrylic homopolymer *⁶ | 5.00 | 5.00 | 5.00 |
| Protease | 2.25 | 2.25 | 2.25 |
| Amylase | 0.50 | 0.50 | 0.50 |
| AMPS/N-Vinylpyrrolidone | 0.30 | 0.50 | 0.70 |
| copolymer crossed | | | |
| linked with TMPTA *³ | | | |
| MGDA *⁷ | 32.50 | 32.50 | 32.50 |
| PEG 4000 | 2.50 | 2.50 | 2.50 |
| C8-14 alkoxylate *⁹ | 2.40 | 2.40 | 2.40 |
| Glycerol 99% | 0.50 | 0.50 | 0.50 |
| Fragrance | 0.15 | 0.15 | 0.15 |
| Total | 100.00 | 100.00 | 100.00 |

*⁹ Plurafac^{RTM} LF 305 (ex BASF^{RTM,} Germany)

The dissolution time of the three formulae was tested by the method given for Example 1.

A longer dissolution time under the above test methods is preferred. The dissolution time at 40° C. for each formula was;

Formula 1—434 seconds
Formula 2—523 seconds
Formula 3—588 seconds

The above example clearly demonstrates that the dissolution time for the compositions of the invention can be controlled by varying the amount of the dissolution retarding compound used according to the invention.

1. A shaped body of detergent composition comprising a chemically and/or physically cross-linked dissolution retarding agent, and at least one of a surfactant or builder wherein the dissolution retarding agent comprises a copolymer formed from the copolymerisation of acrylamidoalkylsulphonic acids with either;
a) at least one cyclic N-vinylcarboxamide, vinyl acetate, ethyleneimine, vinyl imidazole, acrylic acid or maleic acid, or
b) (i) at least one cyclic N-vinylcarboxamide, vinyl acetate, ethyleneimine, vinyl imidazole, acrylic acid or maleic acid and (ii) at least one linear N-vinylcarboxamide, or the alkali metal, alkaline earth metal, ammonium or transition metal salt thereof.

2. A shaped body according to claim 1, wherein the dissolution retarding agent comprises a cross-linked copolymer comprising;
a1) 1 to 50% by weight of either the repeating structural unit of formula [1]; 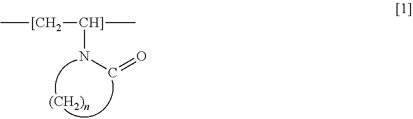
where n is an integer from 2 to 9; or vinyl acetate, ethyleneimine, vinyl imidazole, acrylic acid or maleic acid, or
a2) 1 to 50 wt % of a mixture of (i) the repeating structural unit of formula (1) or vinyl acetate, ethyleneimine, vinyl imidazole, acrylic acid or maleic acid and (ii) the repeating structural unit of the formula [2]; 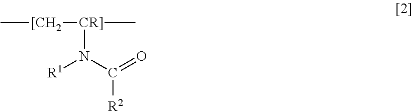
wherein R, R¹ and R² may be identical or different and are hydrogen or a linear or branched alkyl or alkenyl group having in each case 1 to 30 carbon atoms and
b) 49.99 to 98.99% by weight of the repeating structural unit of the formula [3]; 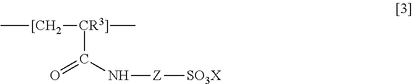
in which R³ is hydrogen, methyl or ethyl, Z is C₁-C₈-alkylene, n is an integer from 2 to 9, and X is an alkali metal ion, an alkaline earth metal ion, ammonium or a transition metal ion, and
c) 0.01 to 8% by weight of cross-linking structures resulting from monomers having at least two olefinic double bonds.

3. A shaped body according to claim 2, wherein the dissolution retarding agent comprises a copolymer comprising;
a) from 3 to 15 wt % of the structural units of the formula (1), or (1) and (2),
b) from 84.5 to 96.5 wt % of structural units of the formula (3),
c) from 0.5 to 2 wt % of cross-linking structures resulting from monomers having at least two olefinic double bonds,
or the alkali, alkaline earth metal, ammonium or transition metal salts thereof.

4. A shaped body according claim 3, wherein the dissolution retarding agent comprises a copolymer comprising;
a) from 3 to 15 wt % of structural units derived from N-vinylpyrrolidone,
b) from 84.5 to 96.5 wt % of structural units derived from a salt of 2-acrylamido-2-methylpropanesulphonic acid, and
c) from 0.5 to 2 wt % of cross-linking structures resulting from monomers having at least two olefinic double bonds,
or the alkali, alkaline earth metal, ammonium or transition metal salts thereof.

5. A shaped body according to claim 2, wherein the cross-linking structure (c) is derived from monomers of the formula (4), in which R is hydrogen, methyl or ethyl;

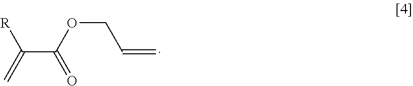

6. A shaped body according to claim 2, wherein formula [1] is N-vinylpyrrolidone, formula [3] is 2-acrylamido-2-methylpropanesulphonic acid and formula [4] is trimethylolpropanetriacrylate.

7. A shaped body according to claim 1, wherein the dissolution retarding agent is a salt of sodium, potassium, ammonium, magnesium, calcium, manganese, zinc, bismuth or cobalt.

8. A shaped body according to claim 1, wherein the dissolution retarding agent is water-soluble or water-swellable.

9. A shaped body according to claim 1, wherein the composition comprises an amount of from 0.01-10% wt of the dissolution retarding agent.

10. A shaped body according to claim 1, wherein the builder comprises at least one of polycarboxylate builders, succinate builders, amino acid based builders and/or phosphorous based builders.

11. A shaped body according to claim 1, wherein the composition comprises an amount of from 5 to 80% wt of builder.

12. A shaped body according to claim 1, wherein the surfactant comprises a non-ionic surfactant, preferably in an amount of from 0.2 to 30% wt.

13. A shaped body according to claim 1, wherein a shaped body prepared by tabletting 9.5 g of the composition using a Kilian® SP 300 excentric press applying a pressing force of 70 KN resulting in a tablet hardness of between 200 to 400 N has a dissolution time of from 300 to 650 seconds in 40° C. water, tested using a Disintegration-Tester Erweka® ZT 54 machine operating at 68 strokes per minute.

14. A shaped body according to claim 1, wherein the shaped body is produced by compaction of the detergent composition.

15. A shaped body according to claim 1, wherein the shaped body is a dishwashing composition.

16. A detergent delivery cartridge, the cartridge comprising a shaped body according to claim 1

17. A detergent delivery cartridge according to claim 16, wherein the delivery car Midge is a refill device having a plurality of chambers which retain said unit dose elements, the unit dose elements being separate from each other, the delivery cartridge being adapted for engagement in a housing, the housing being built into a dishwasher or independent of the dishwasher.

18. A detergent dispensing device comprising a shaped body according to claim 1.

19. A method of washing wares in an automatic washing machine, the method comprising the step of: utilizing using a shaped body according to claim 1 in an automatic dishwashing machine.

20. A method of washing wares in an automatic dishwashing machine, comprising the step of: utilizing a detergent cartridge according to claim 16 in an automatic dishwashing machine.
